(19) United States
(12) Patent Application Publication
(10) Pub. No.: US 2019/0099786 A1
(43) Pub. Date: Apr. 4, 2019

(54) Cleaning Machines and Mechanical Structures

(71) Applicant: Alain Cerf, Redding beach, FL (US)

(72) Inventor: Alain Cerf, Redding beach, FL (US)

(21) Appl. No.: 15/724,859

(22) Filed: Oct. 4, 2017

(51) Int. Cl. B08B 3/02; F16B 43/00

(52) U.S. Cl. CPC B08B 3/02; F16B 43/00

(57) ABSTRACT

This invention is related to washing mechanical structures so a cleaning fluid flows freely between members of the structures.

This invention is related to washing mechanical structures so a cleaning fluid flows freely between members of the structures. When the cleaning fluid does not flow freely between the structures, contamination remains on the structure.

### BACKGROUND OF THE INVENTION

The prior art washes down machines with cleaning fluids. The fluid does not remove all the contamination because the members of the machine are bolted together impeding the flow of the fluid thereby leaving the contamination on the machine.

### BRIEF DESCRIPTION OF THE DRAWING

FIG. 1 shows members bolted together using a spacer to separate the members.

### DETAILED DESCRIPTION OF THE INVENTION

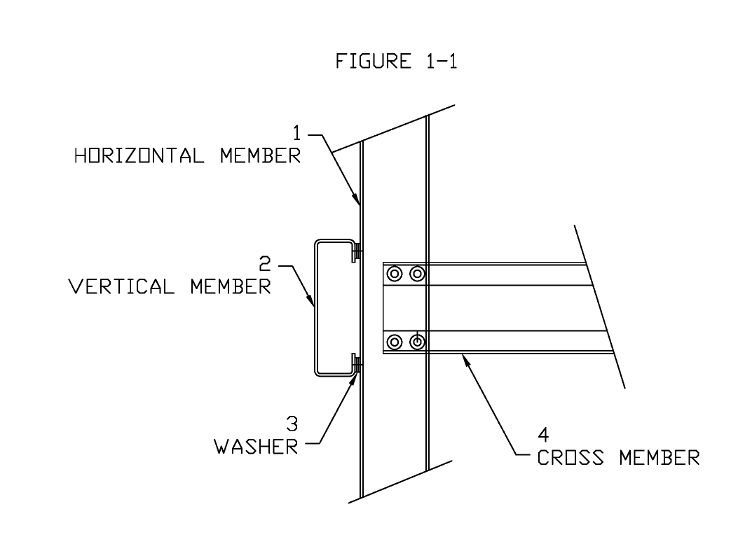

FIG. 1 shows members 1,2, and 4 where the bolts are separated by a thick washer 3. Usually the washer is about 16 mm in diameter and 6 mm thick. The thickness should be large enough to form a channel that allows the cleaning fluid with the contaminants to flow freely during the washing of the machine. The washer and bolt should be strong enough to maintain the structural integrity of the machine. The structural members are usually made of stainless steel of about 7 to 11 gauge. An apparatus using these members are designed to avoid any cavity that would retain the fluid.

The cleaning fluid can be applied by spraying or manually applying the cleaning fluid to the apparatus.

1. A process of cleaning a machine comprising
providing a machine having members bolted together wherein the members are separated by a washer with a sufficient thickness that would allow a cleaning fluid to flow freely between the members with the contaminants, and
applying a cleaning fluid for removing contaminants from the members,

2. A process according to claim 1 wherein the washer is at least about 6 mm thick and has a diameter of 16 mm.

3. A process according to claim 1 wherein the machine has no cavities to trap the cleaning fluid.

4. A structural arrangement comprising, a machine having members bolted together wherein the members are separated by a washer with a sufficient thickness that would allow a cleaning fluid to flow freely between the members with the contaminants, and
means for applying a cleaning fluid for removing contaminants from the members,

5. A structural arrangement according to claim 4 wherein the washer is at least about 6 mm thick and a diameter of about 16 mm.

6. A structural arrangement according to claim 4 wherein the machine has no cavities to trap cleaning fluid.
